(19) United States
(12) Patent Application Publication
(10) Pub. No.: US 2007/0240231 A1
(43) Pub. Date: Oct. 11, 2007

(54) Managing objects in a role based access control system

(76) Inventors: Bashir A. Haswarey, Arlington Heights, IL (US); Sanjeev A. Joshi, Wauconda, IL (US)

Correspondence Address: MOTOROLA, INC., 1303 EAST ALGONQUIN ROAD, IL01/3RD, SCHAUMBURG, IL, 60196, US

(21) Appl. No.: 11/392,156

(22) Filed: Mar. 29, 2006

(51) Int. Cl. H04L 9/32

(52) U.S. Cl. 726/28

(57) ABSTRACT

A method and system for managing objects in a O&M RBAC system includes a first step of dynamically discovering an object and associated command actions by the RBAC system. A next step includes defining roles and tasks to users assigning authorization privileges for the object. A next step includes updating a graphical user interface with information about the objects, roles, tasks, and command actions. A next step includes adding information about the objects, roles, tasks, and command actions to a database for the network. A next step includes entering a command with an action from a user. A next step includes determining a role of a requesting user. A next step includes comparing the role against the database to find authorization to execute the task and action against the object.

### FIELD OF THE INVENTION

The invention relates to security in a wireless communication network, and in particular, but not exclusively, to managing objects in a role based access control system.

### BACKGROUND OF THE INVENTION

Security is a continuing issue with network operators. Existing network security features, such as firewalls and virtual private networks, are becoming less and less effective. As a result, there has been a push to incorporate security features in every node of a communication network. However, interoperability requirements between hybrid communication systems such as the Universal Mobile Telecommunication System (UMTS), Global System for Mobile communication (GSM) and Wideband Code Division Multiple Access (GSM/WCDMA) system, or even more basic systems such as Code Division Multiple Access (CDMA) communication systems, has made security deployment in these nodes difficult. In addition, even if security features are pushed out to nodes, network operators must still have a centralized security administrator to control network access.

One existing approach to control access involves an authorization process in the network. Typically, access to communications in a network is controlled by a Policy Enforcement Point (PEP), such as a firewall for example, which controls access. In this way, only authorized users are allowed access to network elements. For example, a Role-Based Access Control (RBAC) system can be used to manage authorization for an Operations and Maintenance (O&M) functions of network elements such as an operations support system. In particular, O&M functions can include configuration management, fault management, performance management, software management, etc.

The RBAC checks that a requesting user has authorization to use the O&M service or function. Particular users have defined “roles” which define which objects or resources that user is allowed to access. The “role” of the user is checked against the known resources or managed objects to determine that user's access. As a result, a centralized security administrator needs to have a view of all of the objects or resources against which security authorization is defined for the particular O&M user. The security administrator also needs to know all of the possible actions (VERBs) of a command that can be executed against the objects or resources. The VERB is the action part of a command (e.g. DISPLAY, MOVE, etc.) The combination of the VERB and its associated object or resource allows the security administrator to assign “roles” to O&M users.

Unfortunately, existing RBAC systems do not provide dynamic discovery of objects or resources and their associated VERBs. As a result, an operator is required to manually update the resources in the RBAC system, which is an added operator expense. In particular, it is left to the security administrator to determine (outside of the RBAC system) all of the VERBs and objects and communicate this information to the RBAC. In other words, the existing O&M RBAC systems do not allow defining of roles at a level of the VERB and object.

What is needed is a RBAC systems that provides discovery of objects and their associated VERBs. Preferably, such discovery is performed dynamically. It would also be of benefit for the O&M RBAC systems to define roles at a level of the object and VERB.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 illustrates an O&M RBAC system, in accordance with the present invention;

FIG. 2 illustrates the structure of the NOMS and NEMS of FIG. 1;

FIG. 3 illustrates a block diagram of tasks in relation to O&M roles, in accordance with the present invention

FIG. 4 illustrates a GUI Main Menu View, in accordance with the present invention;

FIG. 5 Illustrates a GUI Policy Editor View, in accordance with the present invention;

FIG. 6 illustrates a logical flow to execute the GUI to obtain the Main Menu view of FIG. 4;

FIG. 7 illustrates a logical flow to create a new task and user roles from the Main Menu View of FIG. 4;

FIG. 8 illustrates a logical flow to modify or derive tasks and user roles from the Main Menu View of FIG. 4;

FIG. 9 illustrates a logical flow for a user submitting CLI commands to an OMCR for execution, in accordance with the present invention;

FIG. 10 illustrates a logical flow for a user submitting command to an OMCR for execution on a custom interface, in accordance with the present invention;

FIG. 11 illustrates a method in accordance with the present invention;

FIG. 12 illustrates a dynamic discovery system, in accordance with the present invention; and

FIG. 13 illustrates a logical flow for the dynamic discovery system of FIG. 12.

Skilled artisans will appreciate that common but well-understood elements that are useful or necessary in a commercially feasible embodiment are typically not depicted in order to facilitate a less obstructed view of these various embodiments of the present invention.

### DETAILED DESCRIPTION OF EMBODIMENTS OF THE INVENTION

The present invention provides a RBAC system that provides dynamic discovery of objects or resources and their associated VERBs so that the RBAC system is up to date with the access control to the system resources. As a result, the O&M RBAC system can then define roles at a level of the VERB and object or resource. Advantageously, the present invention supports access control at the network management and operation level, as opposed to prior art approaches that supports access control at the operating systems level and enterprise level operations. This is achieved by providing an interface between the access control server and the network element management system. The present invention, although discussed in the context of a cellular wireless network, can be applied to any managed network including but not limited to wireless, wired, computer networks etc.

In particular, RBAC system manages the access control to the resources in the element manager. The element manager discovers resources by readings its local resource repository (which could be a Management Information Base (MIB) database). Then element manager updates RBAC system with new topology enabling a security administrator to assign roles to any users (operators) using meaningful command actions (VERBS) for each of the new targets. Command actions are native to that specific element manager that manages the target objects.

The present invention prevents an unauthorized user from; causing a service interruption (e.g., disabling a network element), modifying a network element (NE) configuration or a master database (DB) such as an unintended modification by an unauthorized novice or an intended modification by a malicious user, and access to performance management (PM) information or call data. In this way, only a user that is assigned access privileges can effect the above modifications.

In practice, a network operator uses an Operation Support System (OSS) to manage NEs and telecom services by performing O&M tasks. Such tasks may include, for example, re-parenting a Base Transceiver System (BTS) (i.e. moving support for a circuit-switched base station and/or packet-switched base station from its parent Central Base Station Controller (CBSC) to another CBSC), provisioning a BTS, collecting call logs, de-commissioning a BTS, performing software upgrades on BTS, PM report generation, etc.

Task commands are originated at an OMCR (Operations and Maintenance Center-Radio) which communicates with base station controllers (BSCs). In addition, some O&M tasks are an aggregate of other O&M tasks or operations. For example, a re-parenting BTS task at the OMCR is composed of four Command Line Interface (CLI) commands with embedded VERBs (e.g. MOVE), such as MOVE PREP, MOVE START, MOVE APPLY, and MOVE FINISH. If an authorized user implements the re-parenting BTS task, execution of the CLI commands provides that; a BSC prepares to move a BTS to a new parent, the move is started, the re-configuration for the move is applied, and then the move is finished, all under control of specific timers.

O&M roles are defined based on the task the operator performs. For example, a BTS Technician Role can be assigned an authorized task of Re-parenting, which allows the BTS Technician access to all commands that are used for re-parenting. For another example, a System Health Monitoring Role can have the authorized assigned tasks of configuration management (CM) that allows the command and VERB of DISPLAY and fault management (FM) that allows the command and VERB of STATUS, which allows the System Health Monitoring user access to all/subset of display/status commands to monitor an NE, and allows access to Alarms/Events. For another example, a CDMA Network Wide Configuration Manager Role can have the authorized assigned tasks of NE Synchronization and configuration management (CM), which allows the Network Wide Configuration Manager access to all commands that are used for re-parenting a BTS, and allows access to ADD/DELETE/EDIT/DISPLAY/SYNC BTS commands.

A novel aspect of the present invention is the dynamic discovery of all valid managed objects or resources and their associated VERBs. Another novel aspect of the present invention allows defining of new roles and allows a network operator to fine tune either new or pre-existing roles through the use of a dynamic graphical user interface (GUI) to the network security administrator.

The following description focuses on embodiments of the invention applicable to a cellular communication system and in particular to a GSM/WCDMA cellular communication system. However, it will be appreciated that the invention is not limited to this application but may be applied to many other communication systems.

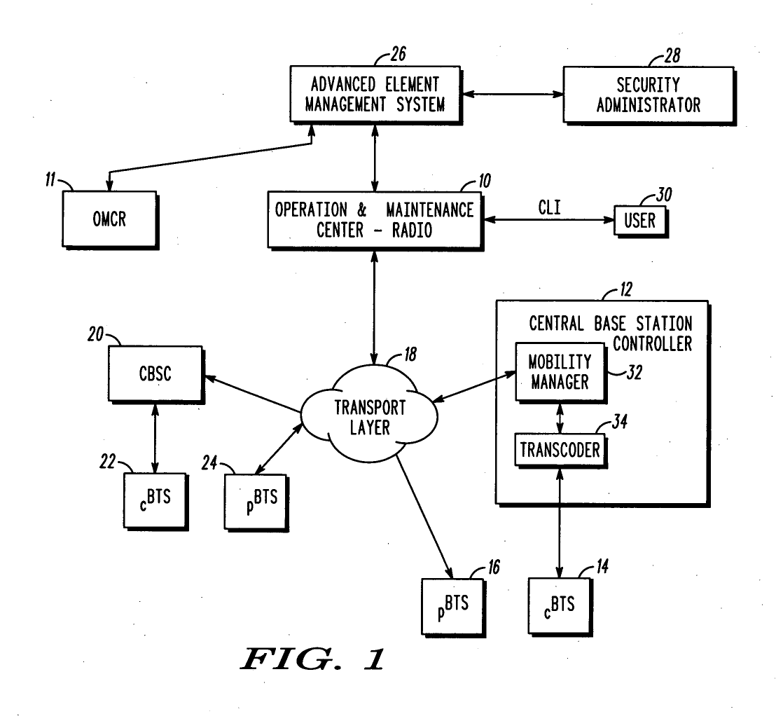

FIG. 1 shows an Operations and Maintenance RBAC system interface with a network. An Advanced Element Management System (AEMS) 26 is controlled by a security administrator 28. The AEMS communicates with one or more Operation and Maintenance Center-Radio (OMCR) 10, 11, wherein the security administrator establishes authorizations for users 30. Each OMCR 10 communicates through the transport layer 18 to its associated Radio Network Controllers (RNCs) or Central Base Station Controllers (CBSC) 12, 20. Each CBSC controls its associated base station transceivers (BTSs), such as control of circuit-switched BTS 14 and control of packet BTS 16 through the transport layer. Each CBSC 12 includes a mobility manager 32 to manage handovers, for example, and a transcoder 34 to communicate with the base stations.

The security administrator 28 defines the authorization of a user 30, such that the user 30 is allowed to execute CLI commands to perform a task. For example, a user 30 can be authorized to provide re-parenting of cBTS 14 from CBSC 12 to CBSC 20.

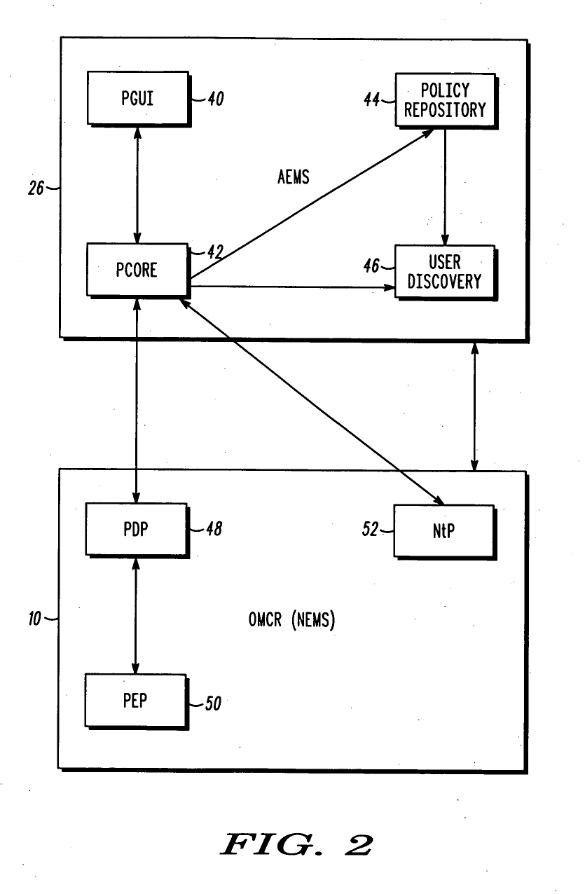

FIG. 2 shows a more detailed view of the AEMS 26 and OMCR 10 in order to demonstrate their interaction in accordance with the present invention. A policy GUI (PGUI) 40 is a front-end GUI using an OSS topology to create tasks (O&M transactions) and role assignments by the security administrator as will be expanded upon below. A Policy Repository (PR) 44 stores an O&M user database and accounts of authorized users, their defined roles with associated O&M tasks, and user RBAC policies. The PR uses Lightweight Directory Access Protocol (LDAP) to manage task definitions and roles for users. The PR can be in a single location or can be deployed anywhere on the network as a distributed service. However, all RBAC components interface with the same instance of the PR. User discovery (UD) 46 retrieves the user list from the PR 44 using LDAP. The policy core (PCORE) 42 provides the runtime environment and underlying infrastructure for the AEMS 26. A policy manager, which can be implemented into either the OMCR or preferably the AEMS, communicates with the PGUI 40, UD 46 and NtP 52.

In the OMCR 10, a Policy Decision Point (PDP) 48 is a specific application where policy decisions are made. The PDP verifies access privileges using the VERB and associated target object. The PDP is shown implemented in the OMCR, but it can be implemented in the other network element managers (NEMs) such as an Operations and Maintenance Center-Data Only (OMC-DO) system, fault management server, or performance management server. The PDP interfaces with PR to obtain RBAC policies. The PDP normalizes the native O&M syntax and semantics for communication with the Policy Enforcement Point (PEP) 50. The PEP is a network element to enforce the policy decisions of the PDP. The PEP will process an event and forward a request to the PDP. The PDP will respond with a decision and actions for the PEP to implement. A typical PEP may be a firewall, VPN, router, etc. A Network Topology Plug-in (NtP) 52 is an application used for providing OSS topology for the PGUI presentation. The NtP includes all possible actions (VERBS) against the managed objects.

In addition, the NtP will occasionally read the network Management Information Base (MIB) database and send any newly discovered objects and associated VERBs to the PGUI, thereby providing dynamic discovery of new objects and actions, as will be detailed below. In addition, each element manager of the network can be informed of the addition of any new objects and actions.

In operation, the PDP takes a user's name and CLI command they are trying to execute, and checks the user name against the policy allowance for the associated object to see if the command should be allowed. The PEP enforces policy rules against the user initiated request, and interfaces with PDP for user initiated request validation. Enforcements are executed at points where O&M users submit or initiate requests. This can be done is a wizard based configuration, for example, wherein once the wizard validates the action against an object, the system will allow the execution of all associated CLI commands to completion.

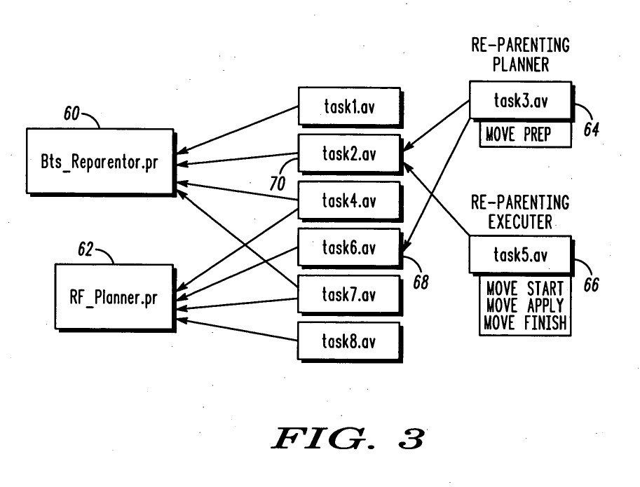

Referring to FIG. 3, O&M tasks can be shared or aggregated to include other tasks of functions, depending upon user roles, in accordance with the present invention. For example, two users (BTS Reparenter 60 and RF Planner 62) have different allowances for a set of tasks. The RF Planner may need to determine how different BTS can be assigned to implement an RF plan. Therefore, the RF Planner is allowed to make preparations for a BTS move (task 3) 64. The BTS Reparenter has increased authority to actually implement the move of a BTS (task 5) 66. However, the BTS Reparenter also has allowance to prepare for a move (task 3). Therefore, BTS Reparenter can have an aggregate task (task 2) 70 that includes task 3 and task 5. The shared authority of BTS Reparenter and RF Planner 62 for a preparation for move provides for a shared task (task3) between task2 70 and task6 68.

The present invention provides a GUI interface 40 that supports two functions: management of user privileges, to associate tasks to users, and defining new tasks or fine tuning existing tasks. The GUI allows extensions to provide a complete OSS view of the system. For example, the GUI can display OSS Managed Object view and associated actions, or display O&M users, as will be detailed below. The policy manager interfaces with LDAP PR 44 to discover users and manages tasks/user per RBAC policies for presentation on the GUI.

The GUI is used to define new O&M user roles or fine tune existing O&M user roles. It is envisioned the predefined roles can be provided by default. For example, one predefined role can be CDMA O&M Security Administrator (e.g., O&M Security Admin who defines user profiles and is a member of OS Admin group). Another predefined role can be CDMA O&M Administrator (e.g., O&M Operator). In addition, the present invention provides that additional roles can be defined per network operator needs.

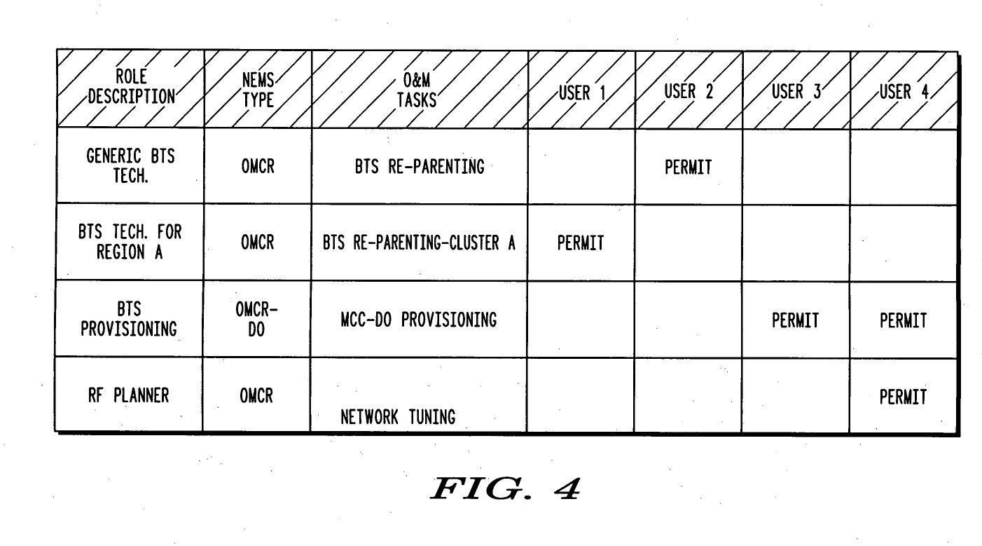

FIG. 4 illustrates the GUI showing the Main View that a security administrator would use to assign roles to users. In this view the security administrator can access and modify existing role descriptions or create new descriptions. For simplification, it is envisioned that the GUI provide a pull down menu for each O&M task box. For example, the pull down menu can include options for adding a new task, modifying a task, deleting a task, or deriving a task. In addition, further descriptions could be provided. Each Role is associated with a NEMs (e.g. OMCR, OMCR-DO, FM server, Pm server, etc.). Each Role is also associated with a particular O&M task, which can be a shared task or an aggregate task. The security administrator can provide authorizations (PERMIT) to particular named used (User 1-4).

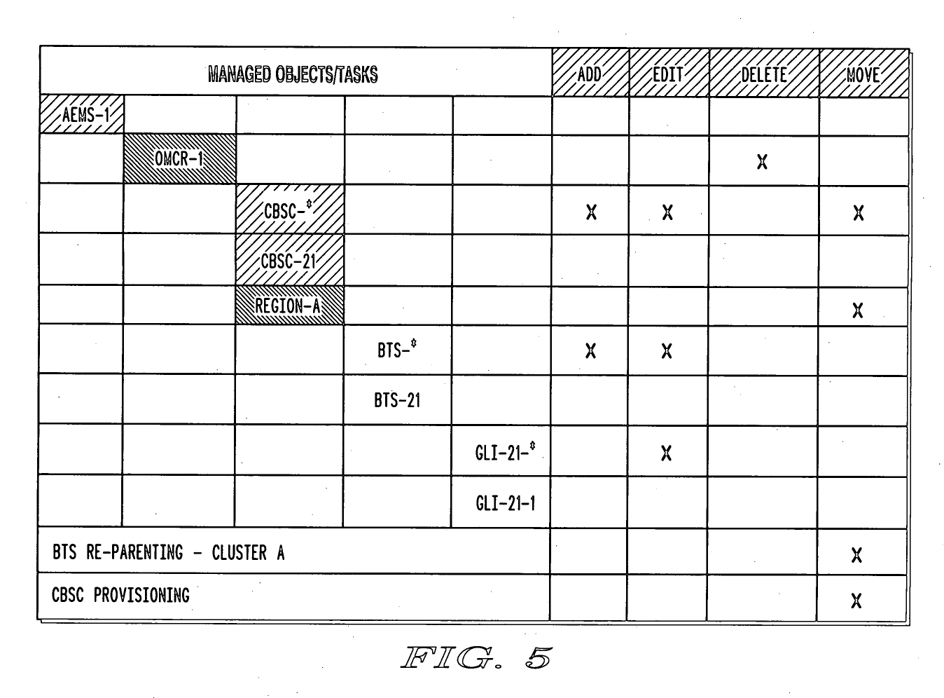

FIG. 5 illustrates the GUI showing a Policy Editor View that a security administrator or other approved user would use to define an O&M task. In this view, a user is authorized to exercise particular actions (VERBs) for a managed object or task. For example, the BTS technician for Region A, who is authorized to perform the task of BTS Re-parenting for cluster A (see FIG. 4) is only allowed to use the MOVE action (VERB) in a CLI command (i.e. MOVE PREP, MOVE START, MOVE APPLY, MOVE FINISH) and is not allowed to ADD a BTS, EDIT a BTS configuration, or DELETE a BTS. Preferably, the view can be filtered to provide only those tasks or objects of interest.

In the cases as shown, allowed action commands are associated with tasks (e.g. BTS Re-Parenting—Cluster A) or managed objects (e.g. CBSC-* (all CBSCs)). The above role/task/object/action associations are then stored in the policy repository (44 in FIG. 2) to be used by the PDP and PEP to decide whether to allow a particular user to execute any particular command. If a user does not have authorization for an entered action for a particular task/object, then the command is not allowed to be executed.

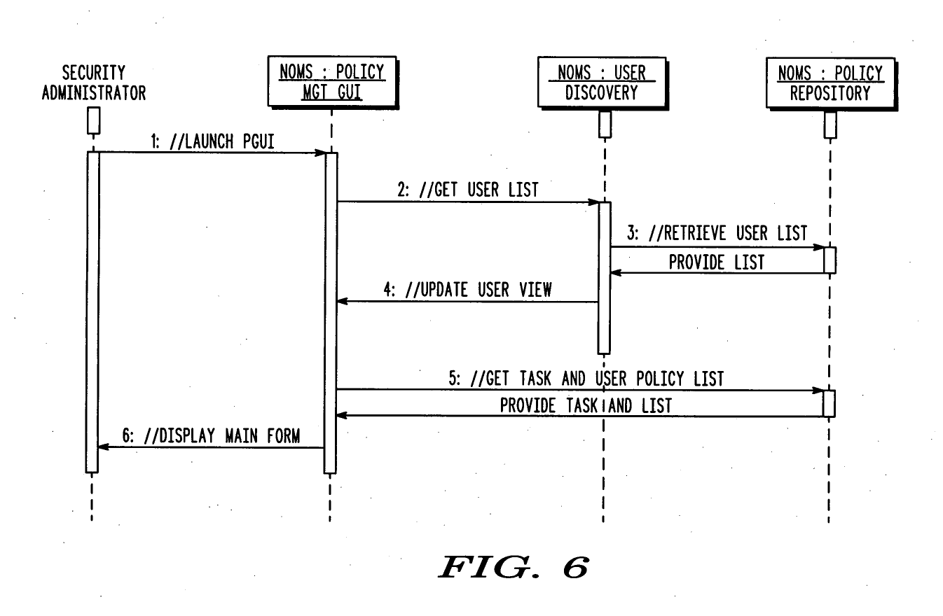

FIG. 6 shows a logical flow in executing the GUI for the first time by the security administrator to obtain the Main Menu view of FIG. 4. In step 1, (and referring back to FIG. 2) the security administrator launches the PGUI 40 in the AEMS or other Network O&M system (NOMS). In step 2, the policy manager (which may be implemented in PCORE 42) orders a user list from the UD 46. The UD may have the list in cache, but if not the UD can retrieve the user list from the PR 44. In either case, the UD provides the user list for updating the user view of the GUI in step 4. The GUI 40 can then retrieve the task and user policy list from the PR 44 in step 5. In step 6, the information can be displayed in the Main Menu View of FIG. 4 for editing by the security administrator.

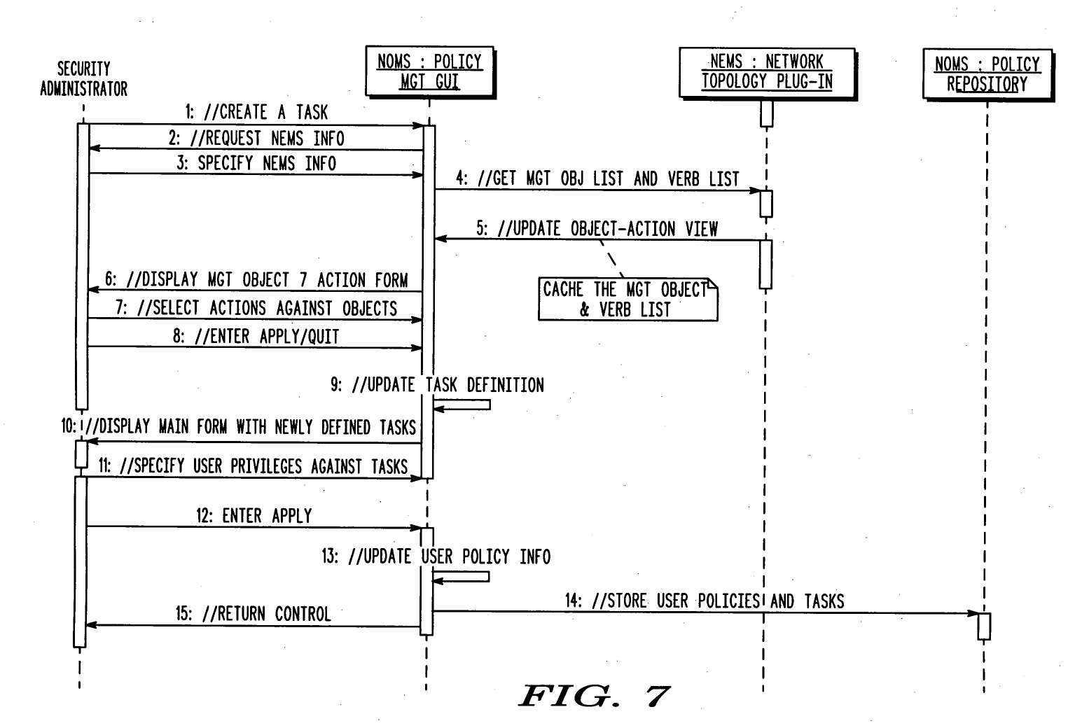

FIG. 7 shows a logical flow for the security administrator to create tasks and user roles from the Main Menu View of FIG. 4. In step 1, (and referring back to FIG. 2) the security administrator creates a new task in the Main Menu by sending a request to the policy manager (which may be implemented in PCORE 42). The policy manager requests NEMS information for the new task in step 2, which is specified by the security administrator in step 3. In step 4, the policy manager requests the list of managed objects and associated actions. (VERBs) from the NtP 52. In step 5, the list is sent from the NtP to the policy manager (which may cache the list), which displays the updated object/action items in the Policy Editor View of FIG. 5 in step 6. In step 7, the security administrator can edit the actions allowed for each task/object. In step 8, the security administrator can either cancel the changes or direct the policy manager to apply the changes, whereupon the policy manager updates the task definition (step 9). At this point, the security administrator can display the Main Menu View to view the newly modified tasks (step 10). The security administrator can then specify the user privileges for the shown tasks (step 11). In step 12, the security administrator can either cancel the changes (not shown) or direct the policy manager to apply the changes, whereupon the policy manager updates the user role information (step 13). These updated roles, policies and tasks can then be stored in the PR (step 14), whereupon control in returned to the security administrator in step 15.

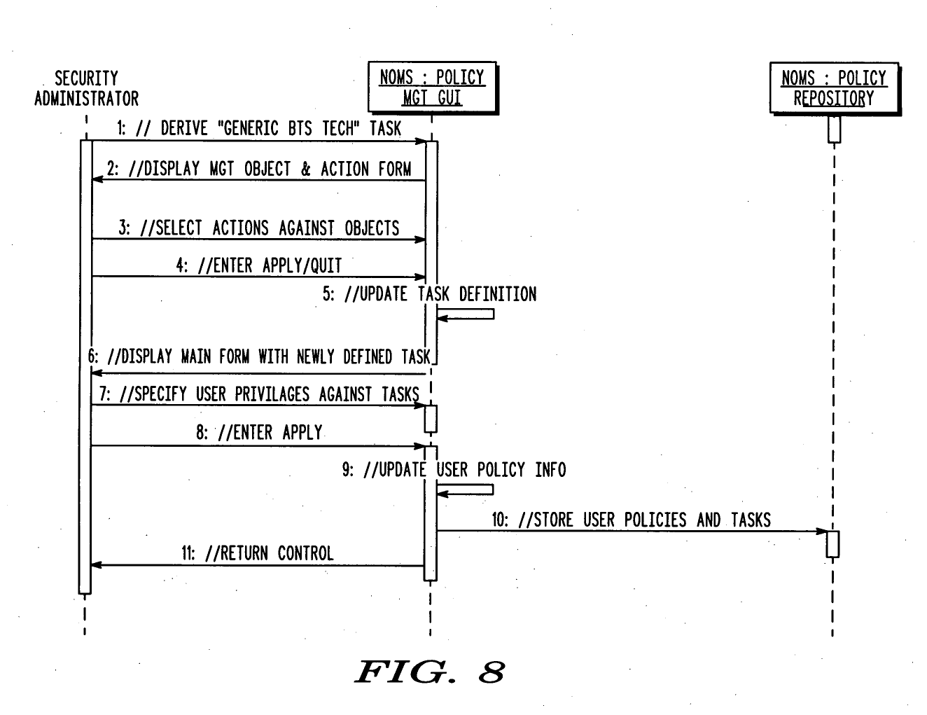

FIG. 8 shows a logical flow for the security administrator to modify or derive tasks and user roles from the Main Menu View of FIG. 4. In step 1, (and referring back to FIG. 2) the security administrator modifies or derives a task (e.g. “Generic BTS Tech” task) from the Main Menu by sending a request to the policy manager (which may be implemented in PCORE 42). In step 2, the list is sent from the policy manager to the security administrator for displaying the updated object/action items in the Policy Editor View of FIG. 5. In step 3, the security administrator can edit the actions allowed for each task/object. In step 4, the security administrator can either cancel the changes or direct the policy manager to apply the changes, whereupon the policy manager updates the task definition (step 5). At this point, the security administrator can display the Main Menu View to view the newly modified tasks (step 6). The security administrator can then specify the user privileges for the shown tasks (step 7). In step 8, the security administrator can either cancel the changes (not shown) or direct the policy manager to apply the changes, whereupon the policy manager updates the user role information (step 9). These updated roles, policies and tasks can then be stored in the PR (step 10), whereupon control in returned to the security administrator in step 11. The logical flow for a security administrator to delete a task will not be demonstrated for brevity and due to its trivial nature.

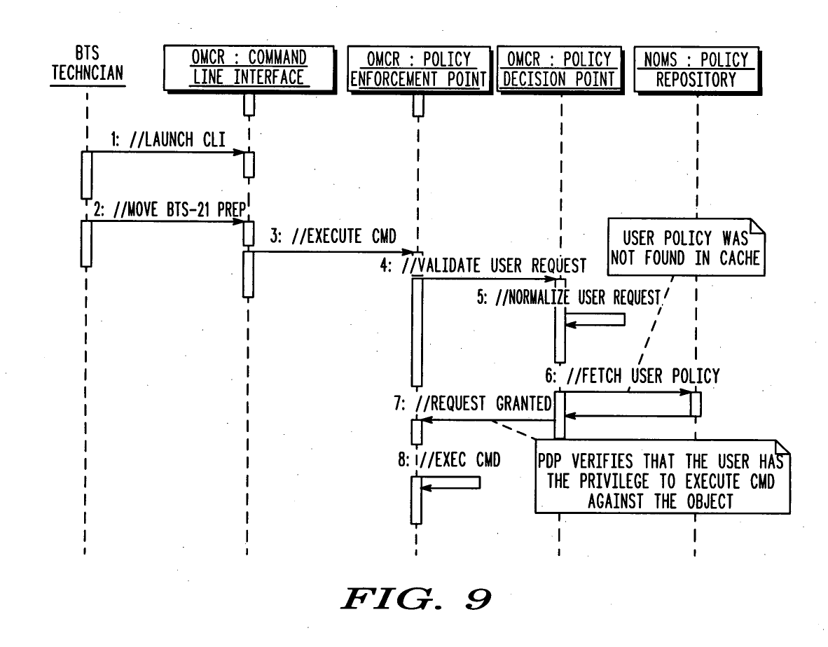

FIG. 9 shows a logical flow for a user submitting CLI commands to an OMCR for execution. In this example, a BTS technician is attempting to execute a first command (MOVE PREP) for the Re-parenting of a BTS. In step 1, (and referring back to FIG. 2) the BTS technician opens a command line interface (CLI). In step 2, the BTS technician enters a CLI command to MOVE PREP BTS-21. In step 3, the BTS technician submits the command to the PEP 50 for execution. In step 4, the PEP confers with the PDP 48 to obtain a decision as to whether to comply with the command. In step 5, the PDP normalizes the request. If the PDP does not have the user policy in cache, the PDP requests the user policy from the PR 44 (step 6). In step 7, assuming the user role matches the user policy for allowing the privilege to execute the command against the managed object, the decision to grant the request is sent from the PDP to the PEP, whereupon the PEP executes the command (step 8).

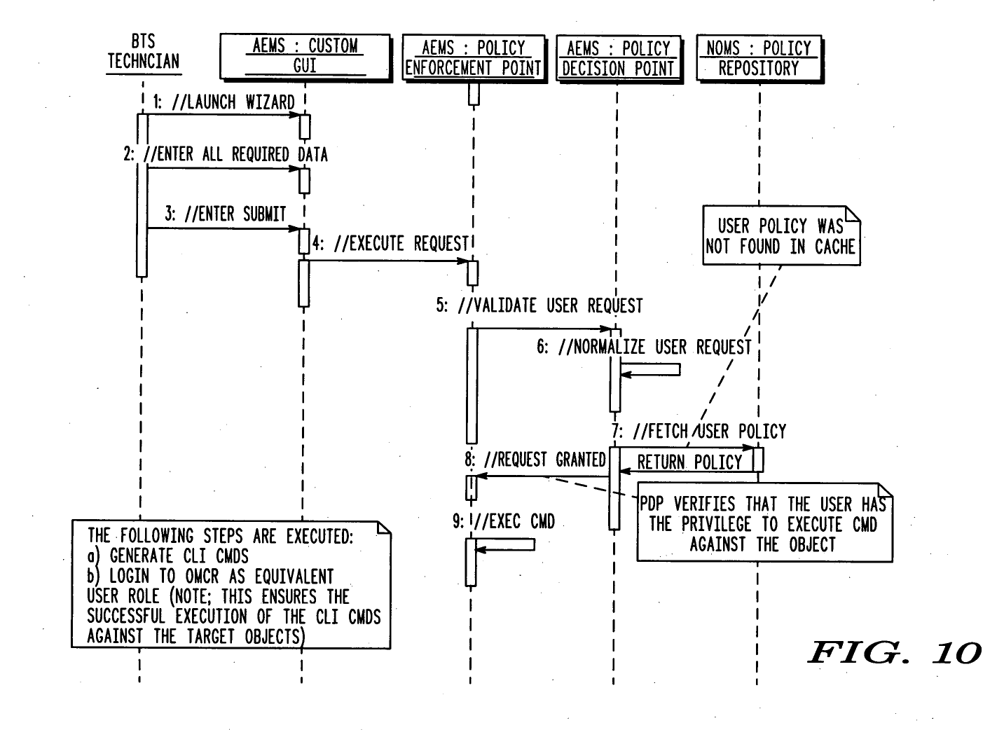

FIG. 10 shows a logical flow for a user submitting command to an OMCR for execution on a custom interface such as an interface of a network operator. In this example, a BTS technician is attempting to execute a first command (MOVE PREP) for the Re-parenting of a BTS from a custom GUI. In step 1, (and referring back to FIG. 2) the BTS technician launches the custom interface (e.g. wizard) and enters all required data (step 2). In step 3, the BTS technician submits the information. In step 4, the custom GUI then executes a request with the PEP 50 for execution of the instructions. In step 5, the PEP confers with the PDP 48 to obtain a decision as to whether to comply with the command. In step 6, the PDP normalizes the request. If the PDP does not have the user policy in cache, the PDP requests the user policy from the PR 44 (step 7). In step 8, assuming the user role matches the user policy for allowing the privilege to execute the command against the managed object, the decision to grant the request is sent from the PDP to the PEP, whereupon the PEP executes the command (step 9). In step 9, since no CLI commands have yet been generated, the PEP or entity generates the CLI commands and performs a login to the OMCR as an equivalent or proxy user role, which ensures the successful execution of the CLI commands against the target object.

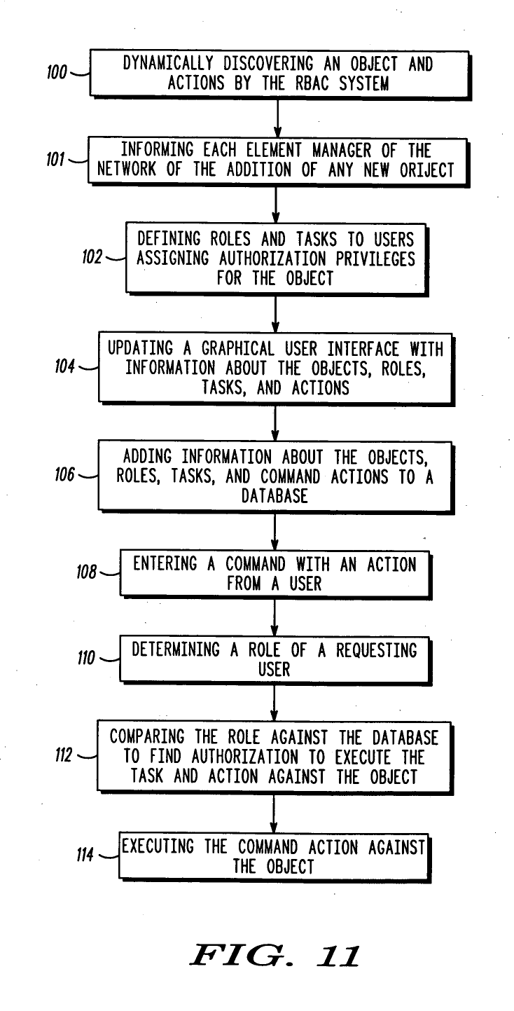

FIG. 11 illustrates a method of for managing objects in a role based access control (RBAC) system, which can communicate with a security administrator, in accordance with the present invention. The method is applicable to the system of FIG. 1. A first step 100 includes dynamically discovering an object, and valid command actions associated with the object, in the network by the RBAC system. A next step 101 includes informing each element manager of the network of the addition of any new objects. A next step 102 includes defining roles and tasks to users assigning authorization privileges for the object. The tasks can be shared between users or aggregated into a single task for a single user. A next step 104 includes updating a graphical user interface with information about the objects, roles, tasks, and command actions. A next step 106 includes adding information about the objects, roles, tasks, and command actions to a database for the network. A next step 108 includes entering a command with an action from a user. A next step 110 includes determining a role of a requesting user. A next step 112 includes comparing the role against the database to find authorization to execute the task and action against the object. A next step 114 includes executing the command action against the object.

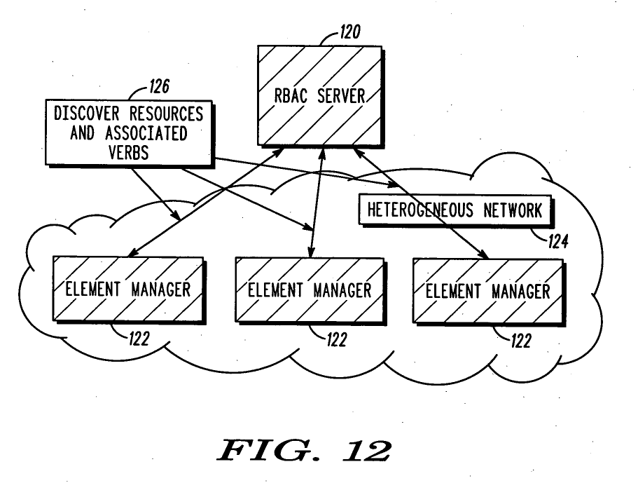

Referring to FIG. 12, dynamic discovery of objects and VERBs involves interaction between the RBAC server 120 and the element managers 122 of the network 124. The element managers 122 are of a heterogeneous type, in the sense that the type of managed objects and associated verbs are not same. The managed object representation and the hierarchical nature are within the context of an element manager 122. The RBAC server 120 is capable of understanding this variance and discovers the managed object tree across all element managers 122.

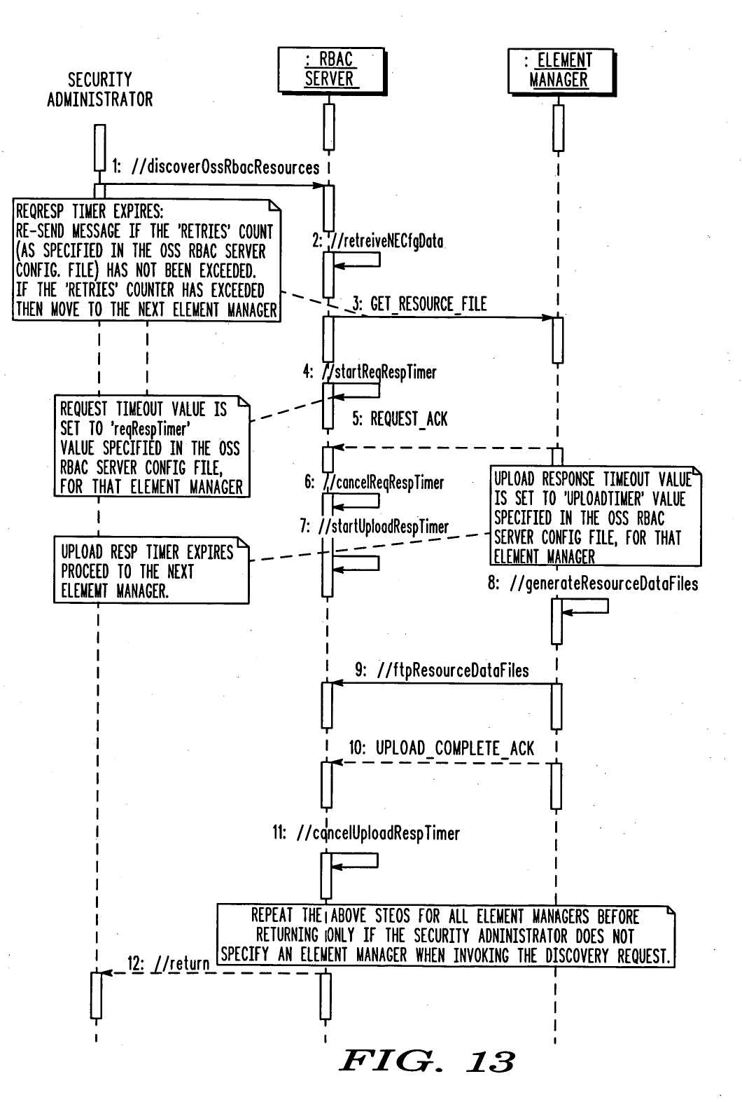

FIG. 13 shows a ladder diagram that describes the discovery mechanism. As shown, the following steps depict the discovery of OSS resources. In step 1, the security administrator or operator of the network invokes discovery of OSS resources. This can be done manually or can be done automatically. In step 2, the policy management entity 126 for the RBAC loads the OSS RBAC Server Configuration file. The policy management entity then retrieves the set of parameters for all of the specified element manager's, which can include; the element manager's IP Address, the element manager's User Datagram Protocol (UDP) port on which the resource discovery entity is listing, a ‘reqRespTimer’ request response timeout value, a ‘retries’ value specifying number of request re-send attempts, and an ‘uploadTimer’ data file upload timeout value.

In step 3, the policy management entity then sends a request containing the file server IP Address and the target directory where the data file must be uploaded. If the resource discovery receives a corrupted request, then it will simply drop the request. In step 4, the policy manager starts the ‘ReqRespTimer’, setting the timeout value to ‘reqRespTimer’ seconds. In step 5, the resource discovery entity acknowledges the request from the Policy Manager. In step 6, upon receiving the acknowledgement message, the policy manager cancels the ‘ReqRespTimer’ timer. In step 7, the policy manager starts the ‘UploadRespTimer’, setting the timeout value to ‘uploadTimer’ seconds. In step 8, the resource discovery entity updates the local dynamic cache (i.e. synchronizes its cache to the element manager's persistent store containing all of the dynamic objects), followed by retrieving the resources in the static and dynamic Resource IDentifier (RID) cache and generates the resource data files; one containing the dynamic objects and the other containing the static resources. In step 9, the resource discovery entity uploads the generated resource data files to the file server to the specified directory location. The method used to upload the files is anonymous ftp.

In step 10, upon completion of the upload to the file server, the resource discovery entity sends an “upload completion” acknowledgement to the policy management entity. In step 11, when the policy manager completes getting the resources from all of the element managers, it returns with an execution completion event to the security administrator or operator. Optionally, in the case where the security admin specifies a particular element manager for object discovery, the policy manager will return right after the execution is completed for that specified element manager. At any point in the above steps the graphical user interface for the security administrator or operator can be automatically updated with any new information, as detailed previously.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for managing objects in a role based access control (RBAC) system, which can communicate with a security administrator, the method comprising the steps of:
dynamically discovering an object in the network by the RBAC system;
defining roles to users assigning authorization privileges for the object;
adding information about the object and defined roles to a database for the network;
entering a command from a user;
determining a role of a requesting user; and
comparing the role against the database to find authorization to execute the command against the object.

2. The method of claim 1, further comprising the step of informing each element manager of the network of the addition of any new objects.

3. The method of claim 1, wherein the discovering step also includes discovering valid command actions for the object.

4. The method of claim 1, further comprising the step of updating a graphical user interface with the information.

5. The method of claim 1, wherein the defining step includes associating authorized tasks for the object to the defined roles.

6. The method of claim 5, wherein the tasks can be shared between users.

7. The method of claim 5, wherein the tasks can be aggregated into a single task.

8. A method for managing objects in a role based access control (RBAC) system, which can communicate with a security administrator, the method comprising the steps of:
dynamically discovering an object, and valid command actions associated with the object, in the network by the RBAC system;
defining roles and tasks to users assigning authorization privileges for the object;
updating a graphical user interface with information about the objects, roles, tasks, and command actions;
adding information about the objects, roles, tasks, and command actions to a database for the network;
entering a command with an action from a user;
determining a role of a requesting user; and
comparing the role against the database to find authorization to execute the task and action against the object.

9. The method of claim 8, further comprising the step of informing each element manager of the network of the addition of any new objects.

10. The method of claim 8, wherein the tasks can be shared between users.

11. The method of claim 8, wherein the tasks can be aggregated into a single task.

12. A role based access control (RBAC) system for managing objects in a network, comprising:
means for dynamically discovering an object in the network by the RBAC system;
means for defining roles to users assigning authorization privileges for the object;
means for adding information about the object and defined roles to a database for the network;
means for entering a command from a user; and
means for determining a role of a requesting user and comparing the role against the database to find authorization to execute the command against the object.

13. The system of claim 12, further comprising means for informing each element manager of the network of the addition of any new objects.

14. The system of claim 12, wherein the means for discovering also includes discovering valid command actions for the object.

15. The system of claim 12, further comprising means for updating a graphical user interface with the information.

16. The system of claim 12, wherein the means for defining include associating authorized tasks for the object to the defined roles.

17. The system of claim 16, wherein the tasks can be shared between users.

18. The system of claim 16, wherein the tasks can be aggregated into a single task.
